(19) United States
(12) Patent Application Publication
(10) Pub. No.: US 2009/0318217 A1
(43) Pub. Date: Dec. 24, 2009

(54) GAMING DEVICE WITH DURATIONAL GAME ELEMENTS

(75) Inventor: John F. Acres, Corvallis, OR (US)

Correspondence Address: MARGER JOHNSON & MCCOLLOM, P.C., 210 SW MORRISON STREET, SUITE 400, PORTLAND, OR, 97204, US

(73) Assignee: ACRES-FIORE PATENTS, Las Vegas, NV (US)

(21) Appl. No.: 12/469,022

(22) Filed: May 20, 2009

Related U.S. Application Data
(63) Continuation-in-part of application No. 12/144,999, filed on Jun. 24, 2008.

(51) Int. Cl. A63F 9/24; A63F 13/00

(52) U.S. Cl. 463/20; 463/31; 463/30

(57) ABSTRACT

Embodiments of the present invention are directed to a gaming device with durational game elements. The durational game elements can change default settings in the game environment of the gaming device for a specified duration. The duration can be based on a period of time, a number of wins or losses, or a number of games played.

### RELATED APPLICATIONS

This application is a continuation-in-part of U.S. patent application Ser. No. 12/144,999, filed Jun. 24, 2008, entitled GAMING DEVICE WITH UNLOCKABLE FEATURES, the contents of which are hereby incorporated by reference.

### FIELD OF THE INVENTION

This disclosure relates generally to gaming devices, and more particularly to gaming devices with durational game elements.

### BACKGROUND

Playing games of chance is a popular recreational activity. There are many types of games of chance including table games where players wager against a live dealer such as blackjack, Pai Gow, roulette, Baccarat. Other types of games of chance are offered as automated machines. Examples include slots, poker, bingo, etc. Still other types of games of chance allow players to wager against one another, such as a poker table. In return for a wager, games of chance generate randomly determined outcomes, some of which result in a winning event. Games of chance are often played with wagers having financial value but some games of chance are played with points or other freely available currency having no fiscal worth.

Games of chance may be played in casinos, or at home using electronic devices or mechanical equipment. Gambling via Internet, whether for fun or for money, is also a popular activity.

Automated gaming machines typically have a single game environment. For example, gaming machines will have a specific color scheme, specific symbols, etc.; in other words, a specific ‘look and feel’.

One of the problems with conventional automated gaming machines is that the player may become bored with the game environment on a certain gaming machine and decide to stop playing for that reason. Further, there is no incentive for the player to continue to play on any certain gaming machine because the game environment will never change. Consequently, a need remains for a mechanism by which the game environment can be changed over time.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming devices according to embodiments of the invention.

FIG. 3 is a functional block diagram of networked gaming devices according to embodiments of the invention.

FIG. 4 illustrates an example video slot machine according to some embodiments of the invention.

FIG. 5 illustrates an unlockable feature management screen according to some embodiments of the invention.

FIG. 6 illustrates an unlockable feature acceptance screen according to some embodiments of the invention.

FIG. 7 illustrates a conditional unlockable feature acceptance screen according to some embodiments of the invention.

### DETAILED DESCRIPTION

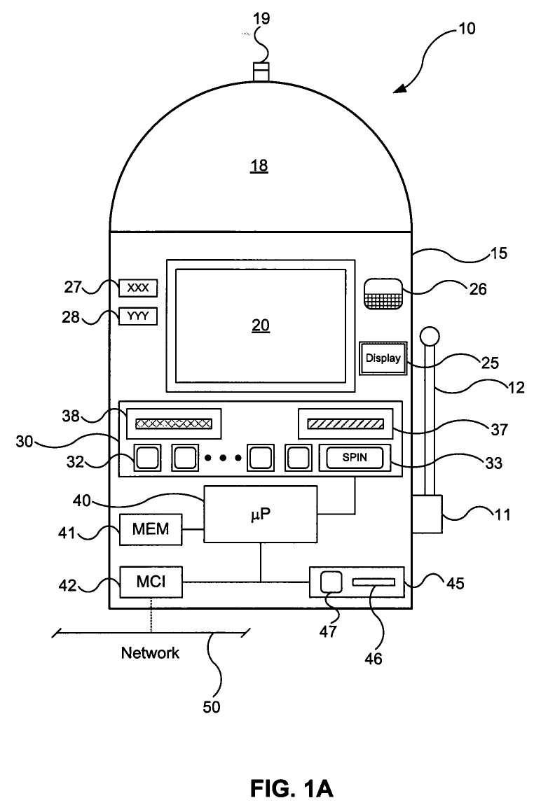

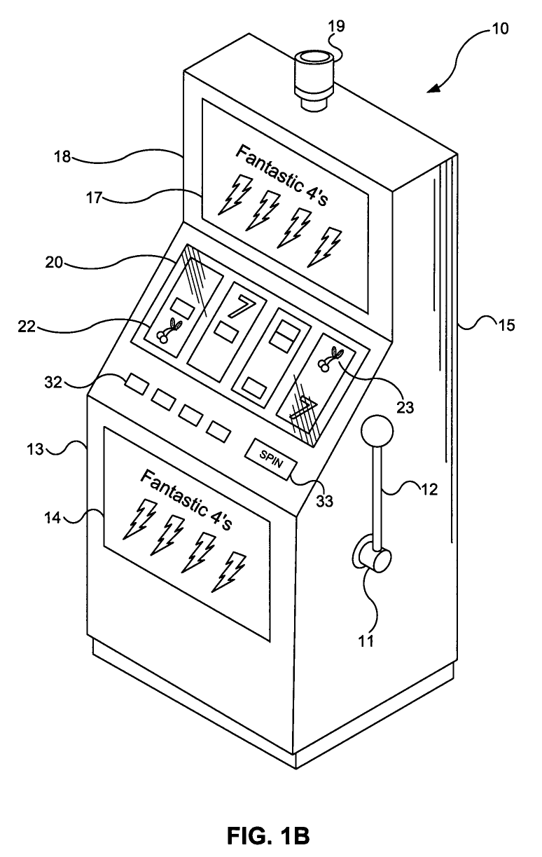

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electro-mechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. Although embodiments of the invention will work with all of the gaming types mentioned, for ease of illustration the present embodiments will be described in reference to the electronic gaming machine 10 shown in FIGS. 1A and 1B.

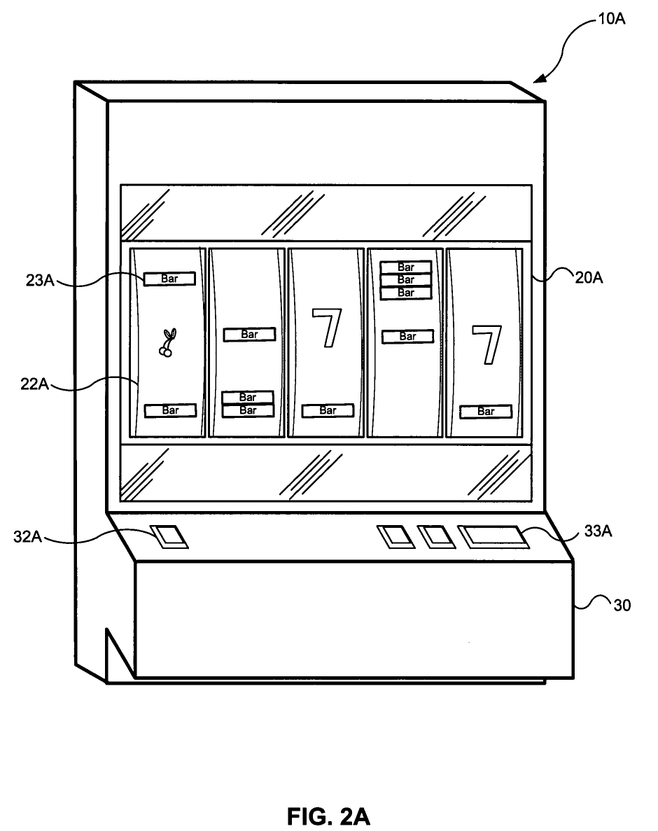

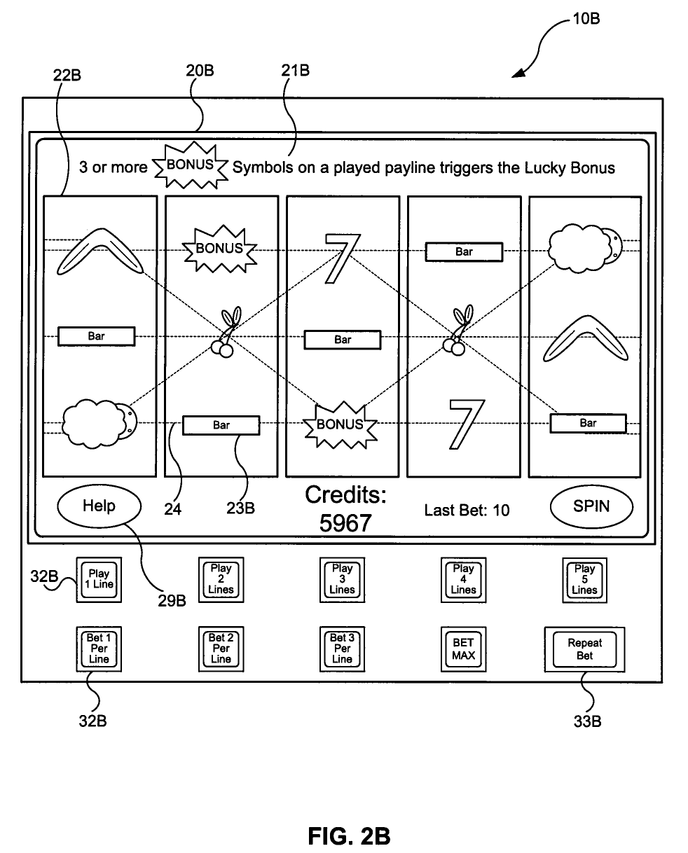

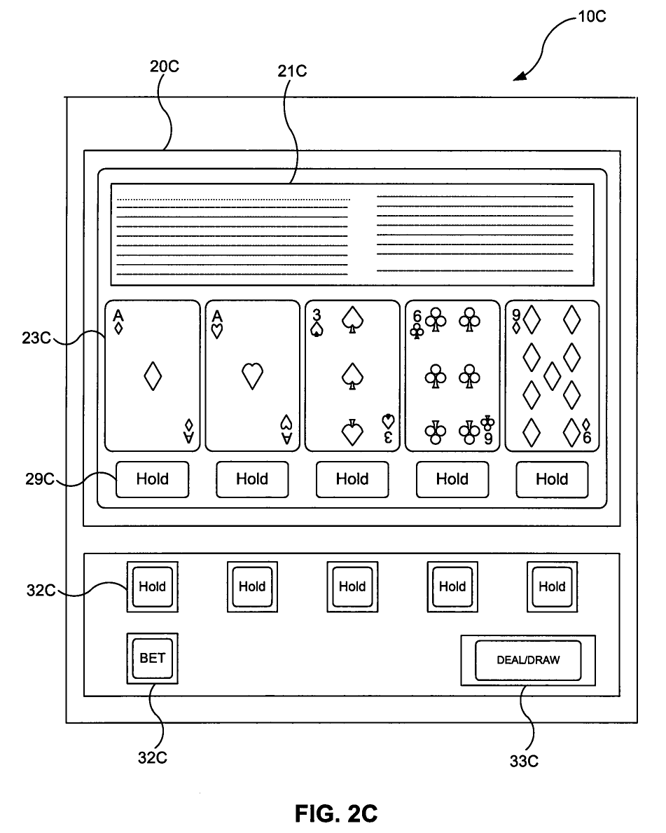

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show ancillary information to the player. For example, the secondary display 25 may show player tracking information, secondary bonus information, advertisements, or player selectable game options.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicate with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

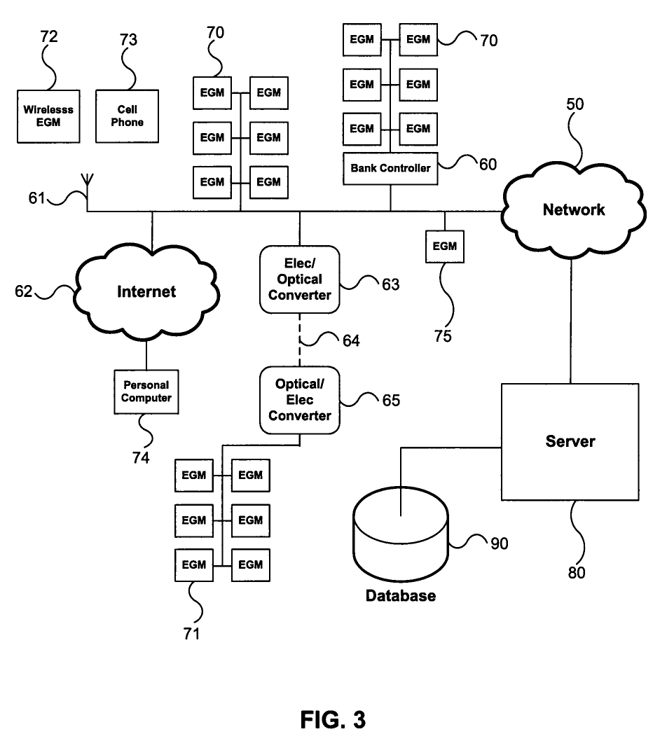

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit card into a card reader/authorizer (not shown). The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2C illustrate exemplary types of gaming devices according to embodiments of the invention. FIG. 2A illustrates an example spinning-reel gaming machine 10A, FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23B appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines various other types of gaming devices known in the art are contemplated and are within the scope of the invention.

Each of the gaming devices in FIGS. 2A through 2C has a game environment. The game environment can include sounds emitted from the gaming device and any portion of the visual information displayed to a player.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, firewire lines, USB lines, or other communication protocols. Although not shown in FIG. 3, substantially the entire network 50 may be made of optical lines 64 or may be a wireless network.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records on in the player database 90 to provide the player with information regarding their player accounts or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

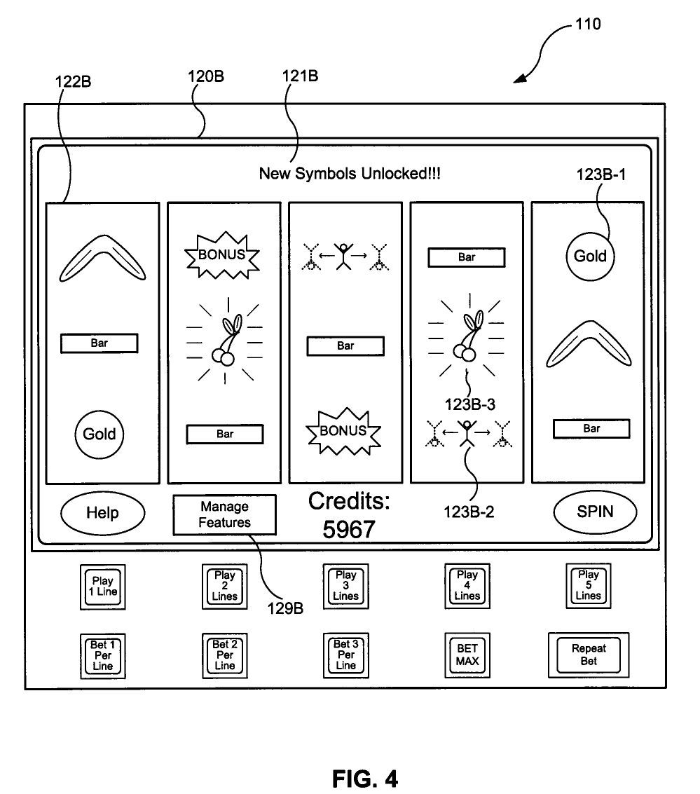

FIG. 4 illustrates an example video slot machine according to some embodiments of the invention.

Referring to FIG. 4, a video slot machine 110 includes unlockable symbols 123B-1, 123B-2, and 123B-3 that are different from the default symbols (i.e., symbols 23B shown in FIG. 2B) displayed on the machine. Unlockable symbol 123B-1 is a static symbol that is different from the default symbols ordinarily displayed on the video slot machine 110. For example, unlockable symbol 123B-1 could be a gold coin that is displayed in place of a specific default symbol on the reels 122B. Unlockable symbol 123B-2 is an animated symbol that is different from the default symbols ordinarily displayed on the video slot machine 110. For example, unlockable symbol 123B-2 could be a stick figure that moves within a pre-defined area of each of the reels 122B (as shown by the dotted figures and arrows) and that is displayed in place of a specific default symbol on the reels 122B. Unlockable symbol 123B-3 is a modified presentation of one of the default symbols ordinarily displayed on the video slot machine 110. For example, unlockable symbol 123B-3 could be a default symbol that has been modified to flash on and off (as shown by dotted accent lines).

A person of ordinary skill in the art will appreciate that unlockable symbols 123B-1, 123B-2, and 123B-3 are just a few examples of many possible unlockable symbols that fall within the scope of the invention. Further, according to some embodiments of the invention, the unlockable symbol 123B could be the same as one of the default symbols, such that triggering the unlockable symbols 123B results in replacement of one of the default symbols with another one of the default symbols. The net effect of such a change is to decrease the total number of symbols present on the reels 122B. The player may perceive this change as increasing the chances of obtaining a win result, but the chances of obtaining a win result are not necessarily increased.

Unlocking of the unlockable features on the video slot machine 110 can be associated with many possible triggers. For example, triggering of a specific unlockable feature can be associated with a pre-set number of consecutive plays by a single player on the video slot machine 110. Many other triggers can lead to unlocking of the unlockable features including, but not limited to: a specific amount of credits wagered by a player; an amount of time the player has spent on a single machine; an amount of credits won by the player on a specific machine; a number of plays without a payout on a specific machine; and trend data associated with the player. Each trigger has an underlying basis. For instance, when the trigger is 500 credits wagered by a player, the underlying basis for the trigger is the number of credits wagered by the player. Also, the unlockable features can be tiered such that a first unlockable feature is unlocked when a first condition is reached, a second unlockable feature is unlocked when a second condition is reached, and so on. The unlockable features can be cumulative, such that the second unlockable feature adds to the first unlockable feature, or the unlockable features can be sequential, such that the second unlockable feature replaces the first unlockable feature.

The triggers that result in unlocking of unlockable features can be machine specific and/or player specific. In other words, the triggers can be tied to the player's use of a specific machine or the triggers can be tied to the player's use of many different machines over time. In the latter case, the player's status with respect to the triggers can be maintained in the player's account. As an example, a trigger for an unlockable feature could be a total amount wagered by a player on a given day, independent of which machines the wagers were placed on. The total amount wagered can be tracked in the player's account such that when the trigger is met, the unlockable feature is unlocked on whichever machine the player is using at that particular time. The unlocked feature can then be available on any machine that the player uses, as long as the player is using their player account on the machine.

The video slot machine 110 can determine whether any unlockable features have been triggered on an ongoing basis as a player sequentially initiates gaming sessions on the machine. If the player provides identifying information to the video slot machine 110, the machine can determine if any unlockable features are available to the player based on the player account associated with the player before the player initiates a first gaming session. Then, video slot machine 110 can determine whether any unlockable features have been triggered on an ongoing basis as the player sequentially initiates gaming sessions on the machine.

As shown in FIG. 4, gaming information 121B can display the status of unlockable features on the video slot machine 110. For example, the gaming information 121B can display a message indicating new unlockable features (new from the player's perspective) have been unlocked. Further, the gaming information 121B can display a message indicating that unlockable features are available and also indicating the conditions upon which the unlockable features can be unlocked.

Many aspects of the game environment on the video slot machine 110 can be altered by unlockable features. For example, the color scheme of the gaming display 120B can be tied to an unlockable feature such that when the unlockable feature is triggered, the colors of different elements in the gaming display 120B can be changed. As another example, the number of reels 122B can be changed when an unlockable feature is triggered. Additionally, the flow of a gaming session can also be altered by unlockable features. For instance, a ‘multiple stops’ unlockable feature can be activated so that the player can stop each reel 122B on a video slot machine 110 independently by sequentially pressing a stop button. Although the player may perceive that the ‘multiple stops’ unlockable feature improves the player's chances of obtaining a win result, this is not necessarily the case.

A person of ordinary skill in the art will appreciate that many other types of unlockable features could be provided and the unlockable features do not have to be specific to the game environment. For example, an unlockable feature could unlock a different game on a particular gaming device, different music (which could be designated in the player account), television programming, and/or drink service. Also, unlockable features could provide features outside the context of the gaming device such as free food (a steak dinner at a particular venue), a free night stay at a particular venue, a ticket to a show, etc. Further, an unlockable feature could be recognition on a public display of the player's accomplishment. For instance, a particular venue may have a display showing a ‘Lucky Players List’ and an unlockable feature could allow the player's name, picture, an animated likeness of the player, etc. to be added to the list.

Another aspect of the game environment that can be modified by the unlockable features is the sound scheme. For example, the background music associated with the video slot machine 110 and the sounds associated with particular events can both be altered by an unlockable feature. Also, event sounds can be tied to the unlockable symbols 123B. In one example, an unlockable symbol 123B could be an animated face that has moving lips timed to correspond with sounds emitted from the speaker 26 to give the impression that the animated face is ‘talking’ to the player. The animated face can provide words of encouragement (i.e., “Give it another try; your luck is bound to change”) or taunt the player (i.e., “Give up now; you're never gonna win”) dependent upon trend data associated with the player. Alternatively, the animated face can simply provide statements that are not tied to any particular trend data (i.e., “Nice weather we're having”).

The unlockable features can be organized into unlockable feature packages. Each unlockable feature package can include multiple unlockable features including, but not limited to: a different color scheme in the gaming display 120B; different unlockable symbols 123B; and a different sound scheme. For example, a ‘stick figure’ unlockable feature package could replace multiple default symbols with animated stick figures performing various activities and sounds corresponding to the various activities. As another example, an ‘animated faces’ unlockable feature package could replace one or more default symbols with animated faces, which may or may not ‘talk’ to the player as described above.

Further, unlockable features from various portions of the gaming display 120B could ‘interact’ with each other. For example, if a ‘stick figure’ unlockable feature package is activated, when the stick figures show up on more than one reel in the gaming display 120B at the end of a gaming session, the stick figures from different reels could interact with each other. For instance, the stick figures could throw a football back and forth while the reels are stopped. A person or ordinary skill in the art will recognize that the ability of game features to interact can itself be an unlockable feature. In other words, the unlockable feature could be the default symbols interacting with each other instead of sitting idle.

Interactions between symbols can take place when the game is idle, right before a gaming session commences, right after a gaming session ends, or during a gaming session. When the interaction occurs during a gaming session, the gaming session may pause to allow the player to see the interaction and then proceed as usual. As an example, while the reels are spinning during a gaming session, the wheels may stop and a stick figure (the moving symbol) from one reel may climb over to another reel and displace one of the symbols (the moved symbol) on the second reel (by kicking the symbol to the stick figure's old spot for example) and then the reels can resume spinning until the gaming session ends.

This in-session interaction can be an indicator that a win result is imminent in the particular gaming session, thus heightening the player's excitement. In other words, either the symbol that moved or the symbol that was moved during the interaction can turn up in the payline of a win result, so that it appears as if the win result is due to the movement of the symbol. Accordingly, players that are familiar with the game will know that when an in-session interaction appears, the player is likely to win, with the only question being whether the player will win based on the moving symbol or the symbol that was moved (with the win amount being determined by which of the symbols the amount is based upon).

Although it may be advantageous to the casino to identify to the player what unlockable features are available on a machine, this does not have to be the case. Unlockable features can be triggered without any prior knowledge by the player. Further, even if the player does know what unlockable features are available, it is not necessary that the player even know what the triggers are for the unlockable features, or in what order the features will unlock. From the player's perspective, the triggering of the unlockable features could be tied to unknown events or even have the appearance of being random. Further, a player could opt out of unlockable features altogether either on a particular gaming device or through an opt-out feature in the associated player account.

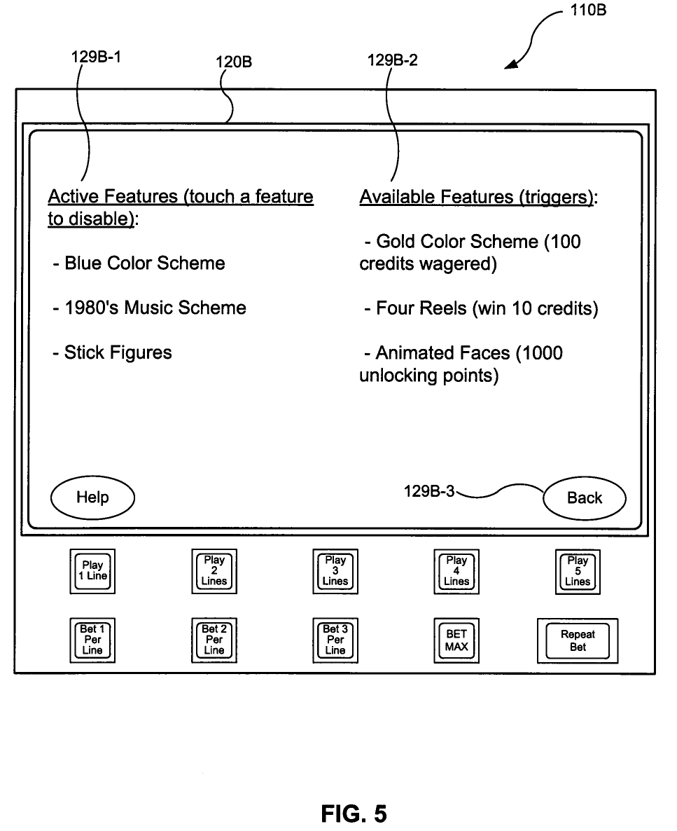

The video slot machine 110 can also include an unlockable feature management button 129B. The unlockable feature management button 129B can be displayed in the gaming display 120B whenever an unlockable feature is active on the video slot machine 110. The unlockable feature management button 129B can be activated by the player (by touching the button on a touch screen, for example) to cause the video slot machine 110 to display an alternate screen as shown in FIG. 5.

FIG. 5 illustrates an unlockable feature management screen according to some embodiments of the invention.

Referring to FIG. 5, upon activation of an unlockable feature management button 129B by a player, the video slot machine 110 can display an unlockable feature management screen in the gaming display 120B. The unlockable feature management screen can include: a list of active unlockable features 129B-1; a list of available unlockable features 129B-2; and/or a close button 129B-3. The list of active unlockable features 129B-1 can display to the player all of the unlockable features that are currently active on the gaming machine. The player can disable any or all of the active unlockable features from the list of active unlockable features 129B-1 by, for example, touching the feature in the list.

The list of available unlockable features 129B-2 can display to the player all of the unlockable features that are available on the machine along with the trigger for unlocking each of the available unlockable features. Alternatively, the list of available unlockable features 129B-2 can display only those unlockable features for which the player is likely to achieve the trigger within a pre-set time interval. For example, if a player has wagered 95 credits on a specific machine and a first unlockable feature is triggered when the player wagers 100 credits, the first unlockable feature may be displayed in the list of available unlockable features 129B-2. On the other hand, if a second unlockable feature is not triggered until the player wagers 1000 credits, the second unlockable feature might not be displayed in the list of available unlockable features 129B-2.

The close button 129B-3 can be used to close the unlockable feature management screen and return to the gaming screen, as shown in FIG. 4. The close button 129B-3 does not necessarily have the word “Close” on it; the button could have any other word that would indicate to the player that they will be returned to the previous screen, such as: “Cancel”, “Return”, or “Back”.

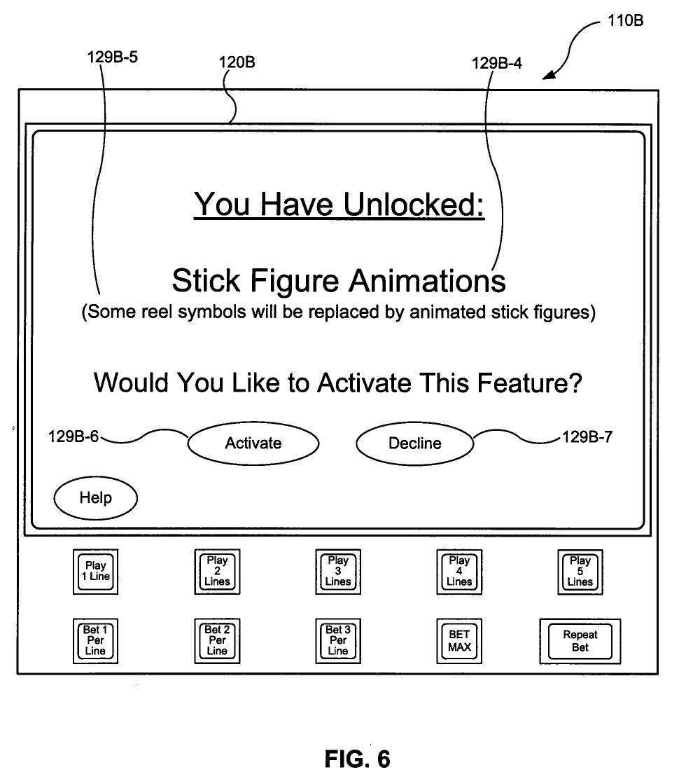

According to some embodiments of the invention, when an unlockable feature is triggered, the gaming device 110 can prompt the player to accept or decline the unlockable feature. The gaming device 110 can prompt the player by, for example, displaying an alternate screen in the gaming display 120, as shown in FIG. 6.

FIG. 6 illustrates an unlockable feature acceptance screen according to some embodiments of the invention.

Referring to FIG. 6, during the course of game play, if a player triggers an unlockable feature, the video slot machine 110 can display an unlockable feature acceptance screen. The unlockable feature acceptance screen can include: an identifier 129B-4 for the triggered unlockable feature; a description 129B-5 of the triggered unlockable feature; an accept button 129B-6; and a decline button 129B-7. The identifier 129B-4 can indicate to the player which unlockable feature has been triggered. The description 129B-5 can provide a brief description of the effect that the triggered unlockable feature will have on the game environment. The accept button 129B-6 and the decline button 129B-7 can be used by the player to either activate the unlockable feature or decline to activate the feature. The accept button 129B-6 and the decline button 129B-7 do not necessarily have the words “Activate” and “Decline” on them. The buttons could have any other words on them that convey to the player that the unlockable feature can be activated or declined including: “Accept”, “Reject”, “Cancel”, or “Continue”.

The triggers for the unlockable features can be linear, non-linear, or a combination of both. For example, a new unlockable feature can be triggered at each linear increment of an underlying basis (i.e., 50, 100, 150 . . . credits wagered on a given machine). Alternatively, a new unlockable feature can be triggered at non-linear intervals of the underlying basis (i.e., 50, 150, 500 . . . credits wagered on a given machine).

According to some embodiments of the invention, the unlockable features can be conditional. As used here, the term conditional means that by choosing to activate a first unlockable feature the trigger point for a second unlockable feature becomes more remote from the player's current status. As an example, the trigger for a first unlockable feature might be 5 minutes of play time on a given machine and the trigger for a second unlockable feature might be 10 minutes of play time on the machine. However, if the player chooses to activate the first unlockable feature when it is triggered, the time is reset, so that the player will have to play for an additional 10 minutes in order to trigger the second unlockable feature. Thus, when the unlockable features are conditional, the player has to play for 15 minutes to unlock both the first and second unlockable features, but if the unlockable features are not conditional, the player would only have to play for 10 minutes to unlock both the first and second unlockable features. When the unlockable features are conditional, the player can activate only the second unlockable feature by declining to activate the first unlockable feature after 5 minutes and accepting the activation of the second unlockable feature after 10 minutes.

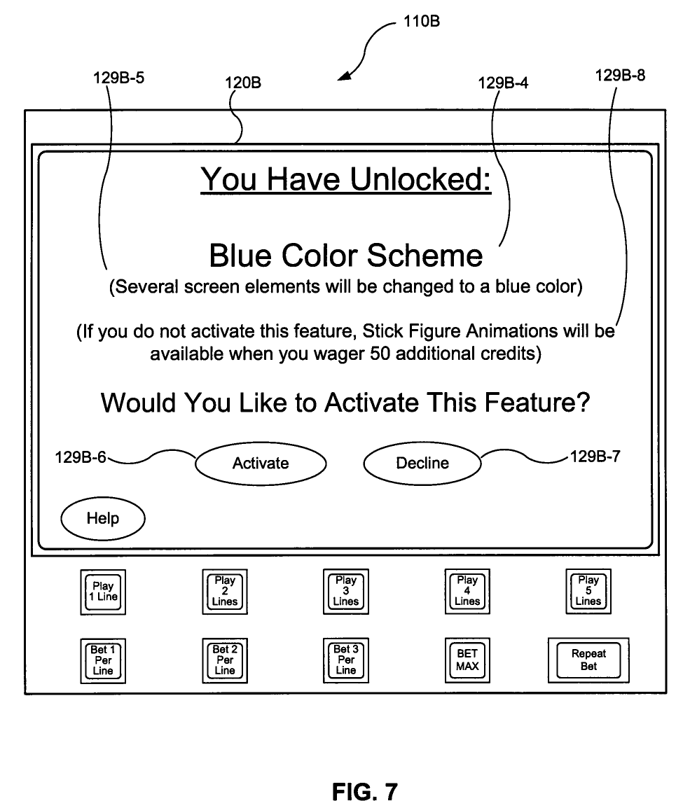

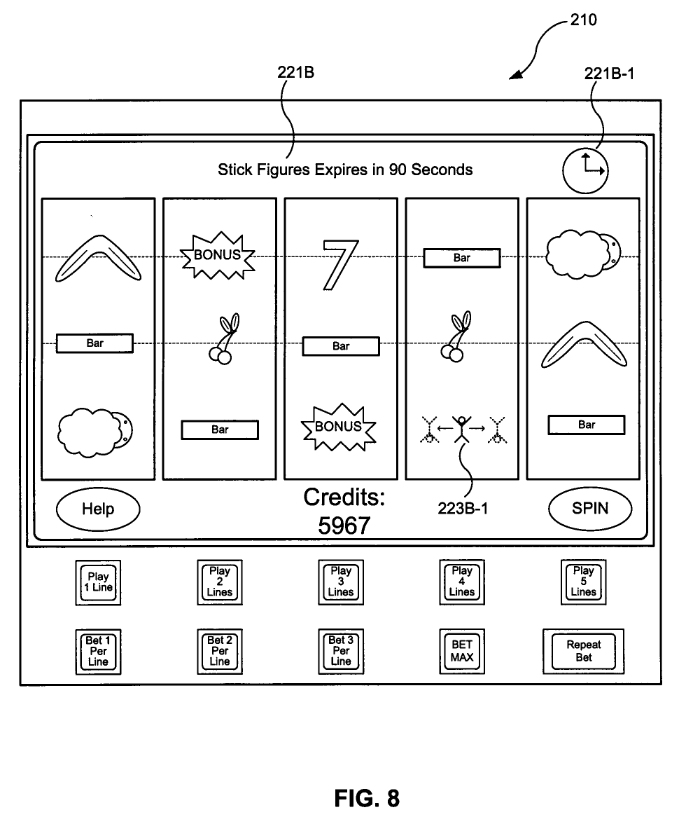

FIG. 7 illustrates a conditional unlockable feature acceptance screen according to some embodiments of the invention.

Referring to FIG. 7, a conditional unlockable feature acceptance screen includes similar features to those described above with respect to FIG. 6. However, the conditional unlockable feature acceptance screen also includes a tempt message 129B-8. The tempt message 129B-8 notifies the player of what unlockable feature will next become available if the player does not activate the currently triggered unlockable feature.

Conditional unlockable features can be especially suited for situations in which later unlockable features are perceived to be ‘better’ by the player than earlier unlockable features in a non-linear fashion. This is the case independent of the validity of the player's perception. For example, the player may perceive that a second unlockable feature, such as ‘fewer number of reels’, is more likely to result in wins for the player than a first unlockable feature, such as a blue color scheme. Therefore, the player may be willing to forego the first unlockable feature so that the second unlockable feature can be triggered sooner. The validity of the player's perception regarding the fewer number of reels is not important. Conditional unlockable features can increase the perception of ‘scarcity’ of the later unlockable features and thus increase the player's excitement at having triggered the later unlockable features.

In some cases, the player may not know which unlockable features become available later, but the player may know that by foregoing the earlier unlockable features, the player increases the chances of triggering the later unlockable features (or decreases the trigger point for the later unlockable features). Additionally, the player may perceive that the later unlockable features are ‘better’ than the earlier unlockable features. Thus, the player may choose to gamble on foregoing the earlier unlockable features in the hopes of triggering the later unlockable features. Such behavior by the player can be termed meta-gambling, as the player is gambling about gambling. Conditional unlockable features can be used to encourage meta-gambling because in addition to the desired outcome of payouts from the gaming machine, the player has a secondary desired outcome of achieving later unlockable features. This meta-gambling effect can be used to encourage a player to prolong play on a given machine or in a given venue, as opposed to changing machines and/or venues.

According to some embodiments of the invention, unlockable features can be managed through the use of unlocking points. A player can accumulate unlocking points on an individual machine basis or on a player account basis. Specifically, the player can accumulate unlocking points while playing on a given machine and the unlocking points can be used to unlock features only on the given machine. Alternatively, the player can accumulate unlocking points on their player account from play on multiple gaming machines and the unlocking points can be redeemed to unlock features on any of the gaming machines. The current number of unlocking points available to a player can be displayed in the gaming display 120B of the video slot machine 110. Alternatively, the player may not even be aware of the existence of the locking points. The number of unlocking points necessary to trigger the next available unlockable feature can also be displayed in the gaming display 120B, as player information 121B for example. Unlocking points can be used to enforce conditional unlockable features because when the player chooses to activate a conditional unlockable feature that has been triggered, the appropriate amount of unlocking points can be deducted from the player account (or the number of unlocking points accumulated on the machine). It should be noted that unlocking points (and unlockable features in general) do not need to be tied to positive player statistics. In other words, a player could accumulate unlocking points even when the player is not getting ‘win’ results from their gaming.

Unlocking points can also be used to tally multiple player statistics into a single value that can be easily redeemed by the player for unlockable features. For example, specified amounts of play time can be tallied as a specific number of unlocking points and the amount wagered by a player on a given day can also be tallied as another specific number of unlocking points. In this way, the unlocking points can represent an aggregate of the many player statistics that can lead to triggering unlockable features.

Alternatively, each player statistic can be tallied as a separate pool of unlocking points. For example, a player account can accumulate first unlocking points that are associated with an amount of time played and second unlocking points that are associated with an amount wagered on a given day. These different unlocking points can be redeemed cumulatively or separately to unlock unlockable features.

A person of ordinary skill in the art will appreciate that different unlockable features can be available on different types of gaming machines. For example, a ‘reduced number of reels’ unlockable feature would be applicable to a video slot machine, but not applicable to a video poker machine. Similarly, an ‘animated card faces’ unlockable feature would be applicable to the video poker machine, but not applicable to the video slot machine. Consequently, the same trigger point for a particular underlying basis can lead to different unlockable features being triggered on different machines. For example, if the underlying basis is amount of credits wagered by a player, at a trigger point of 50 credits, a ‘reduced number of reels’ unlockable feature could be triggered if the player is playing a video slot machine, while an ‘animated card faces’ unlockable feature could be triggered if the player is playing a video poker machine.

Unlockable features can also be organized into levels. In other words, instead of unlocking a specific feature when a certain trigger point is reached, the trigger could be used to set a player level (i.e., Level One, Level Two, Silver Level, Gold Level, etc). The player level can then be used as a proxy for the unlockable features. For example, a Level Two player can have certain unlockable features available, while a Level Three player can have certain additional or different unlockable features available. The player levels can be managed locally on a specific gaming device or they can be managed in the player account.

Also, unlockable features can be organized into categories. For example, unlockable features could include: gaming machine play modes (that affect play on game, reels, etc.); visual or aural game environment features (colors, sounds, etc.); external features (free drink service, steak dinner, show tickets, etc.); and vanity features (overhead displays, recognition messages emanating from the gaming device, etc.). A player could choose which category of unlockable features the player would like to have available either on a machine-specific basis or in the player account.

According to embodiments of the invention, unlockable features can be used to change the game environment on a gaming machine. The unlockable features can be triggered by many different player statistics accumulated on a single machine or multiple machines using a player account.

Any of the unlockable features described above can also be of limited duration. Specifically, when an unlockable feature is activated, a durational limit can also be set. The durational limit can be static in the sense that it is fully defined when the unlockable feature is activated or it could be dynamic in the sense that it can be re-defined after the unlockable feature is activated. The durational limit can be, for example, a period of time, a number of games played, a number of win results, and a number of lose results, among other things. The durational limit can be consecutive or cumulative. For example, if the durational limit is a number of win results, it could be a number of consecutive win results (i.e., consecutive) or it could be a set number of win results without regard to how many lose results are intermingled with the win results (i.e., cumulative). In the case of a dynamic durational limit, the durational limit can be changed responsive to subsequent events on the gaming device. For example, an initial durational limit may be 10 minutes, but the durational limit may be extended to 15 minutes responsive to a specified number of win or lose results in the initial 10 minutes.

As described above, unlockable features do not necessarily have to be accepted or acknowledged by the player to become active. Thus, as the player is playing on a given gaming device, the player may just notice that certain symbols are becoming active on the gaming device and subsequently disappearing after some duration, without the player having any knowledge that this effect was responsive to an unlockable feature being activated.

FIG. 8 illustrates an example video slot machine with a durational game element according to some embodiments of the invention.

Referring to FIG. 8, a video slot machine 210 includes a durational game element 223B-1 that is different from the default symbols (i.e., symbols 23B shown in FIG. 2B) displayed on the machine. In this example, durational game element 223B-1 is an animated ‘Stick Figures’ symbol that is different from the default symbols ordinarily displayed on the video slot machine 210. The durational game element 223B-1 has a durational limit of some time period, 90 seconds of which is remaining, although, as described above, the durational limit could be tied to other events such as number of wins.

As shown in FIG. 8, gaming information 221B can display the status of the durational game element 223B-1 on the video slot machine 210. For example, the gaming information 221B can display a message indicating the amount of time remaining for the durational game element 223B-1. Further, the gaming information 221B can display a timer 221B-1 giving a graphical representation of the time remaining for the durational game element 223B-1.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A method of operating a gaming device of the type having a plurality of symbols from which a subset is selected during the course of the game, the method comprising:
establishing at least one predefined criterion related to at least one gaming-device parameter tracked during play of the gaming device;
tracking the gaming-device parameter during play of the gaming device; and
changing at least one of the symbols for a predefined duration when the tracked gaming-device parameter satisfies the predefined criterion.

2. The method of claim 1 wherein the parameter is selected from the group consisting of credits wagered, consecutive plays by a single player, time spent playing the gaming device, credits won, and number of games played without a win.

3. The method of claim 1 wherein changing at least one of the symbols comprises at least one of changing the symbol to a different symbol, animating the symbol, and changing lighting of the symbol.

4. The method of claim 1 wherein the method further comprises:
offering a player of the gaming device the option to change the at least one symbol when the tracked gaming-device parameter satisfies the predefined criterion; and
changing the at least one symbol upon acceptance of the offer.

5. The method of claim 1 further comprising displaying information about symbols that can be changed to a player of the gaming device.

6. The method of claim 1 further comprising:
identifying a player of the gaming device; and
changing at least one of the symbols based at least in part on information related to the identity of the player.

7. A gaming device comprising:
a plurality of default symbols from which a subset is selected to generate a game outcome;
at least one alternative symbol; and
an actuator operable by a player of the gaming device to substitute for a predefined duration the at least one alternative symbol for at least one of the default symbols.

8. The gaming device of claim 7 wherein the alternative symbol comprises at least one of a different symbol, an animated symbol, and a lit symbol in which the lighting changes.

9. The gaming device of claim 7 further comprising an interface through which an offer to substitute the at least one alternative symbol is made, wherein actuation of the actuator comprises acceptance of the offer.

10. The gaming device of claim 7 further comprising a display on which information about the symbols that can be substituted is presented.

11. A method of operating a gaming device having a plurality of audio-visual features comprising:
establishing at least one predefined criterion related to at least one gaming-device parameter tracked during play of the gaming device;
tracking the at least one gaming-device parameter during play of the gaming device;
offering a player of the gaming device the option to change at least one of the audio-visual features when the tracked gaming-device parameter satisfies the predefined criterion; and
changing at least one of the audio-visual features for a predefined duration upon acceptance of the offer.

12. The method of claim 11 wherein the parameter is selected from the group consisting of credits wagered, consecutive plays by a single player, time spent playing the gaming device, credits won, and number of games played without a win.

13. The method of claim 11 wherein changing at least one of the audio-visual features comprises changing a first symbol to a second symbol, animating the first symbol, and changing lighting of the first symbol.

14. The method of claim 11 further comprising displaying information about features that can be changed to a player of the gaming device.

15. The method of claim 11 further comprising:
identifying a player of the gaming device; and
changing at least one of the features based at least in part on information related to the identify of the player.

16. A gaming system comprising:
a plurality of gaming devices that include a plurality of audio-visual features;
a network interconnecting the gaming devices;
a plurality of player records stored on the network, the player records containing information related to play of the gaming devices by players associated with corresponding records;
at least one predefined criterion related to data stored on the player records;
a first process constructed and arranged to determine whether a player record associated with a player of one of the gaming devices meets the predefined criterion; and
a second process constructed and arranged to change at least one of the audio-visual features of the one gaming device for a predefined duration when the player record meets the predefined criterion.

17. The gaming device of claim 16 wherein at least one of the audio-visual features comprises a plurality of symbols from which a subset is selected during the course of the game.

18. The gaming device of claim 16 further comprising an interface through which an offer to change at least one of the audio-visual features is made.

19. The gaming device of claim 16 further comprising a display on which information about the audio-visual features that can be changed is presented.
